(19) United States
(12) Patent Application Publication
(10) Pub. No.: US 2008/0235411 A1
(43) Pub. Date: Sep. 25, 2008

(54) Peripheral Interface, Receiving Apparatus and Data Communication Method Using the Same

(76) Inventors: Hui Zhang, Beijing (CN); Yunqing Deng, Beijing (CN); Ke Jiang, Beijing (CN); Wei Hu, Beijing (CN)

Correspondence Address: FISH & RICHARDSON PC, P.O. BOX 1022, MINNEAPOLIS, MN, 55440-1022, US

(21) Appl. No.: 12/025,458

(22) Filed: Feb. 4, 2008

(30) Foreign Application Priority Data
Mar. 22, 2007 (CN) 200710064664.4
Mar. 22, 2007 (CN) 200720103920.1

(51) Int. Cl. G06F 13/28

(52) U.S. Cl. 710/28

(57) ABSTRACT

Peripheral interface(s), a receiving apparatus and a data communication method using the same are disclosed. According to an embodiment of the present invention, a peripheral interface comprises one or more pins for multiplexing at least two types of interfaces, wherein the pins transmit interface signals corresponding to an interface type and type-associated operating mode which are selected from those multiplexed by the pins. According to another embodiment, a receiving apparatus comprises: a peripheral interface for multiplexing at least two types of interfaces; a receiving module for receiving an instruction signal; a selecting module for selecting an interface type and type-associated operating mode which corresponds to an external device to be connected, based on the instruction signal; a controlling module for controlling the peripheral interface to communicate with the external device via at least one interface signal corresponding to the selected interface type and type-associated operating mode.

### FIELD OF THE INVENTION

The present invention relates to data transmission field, and in particular, relates to peripheral interface(s), a receiving apparatus and a data communication method using the same.

### BACKGROUND OF THE INVENTION

A Serial Peripheral Interface (SPI) bus system is a synchronous serial peripheral interface allowing a master equipment to communicate and exchange data with multiple types of slave equipments in serial manner. The SPI system has two different operating modes of single-channel and double-channel SPI, wherein the operating mode of double-channel is used mostly. The SPI system is applicable to configure ports with Inter-Integrate Circuit (I²C) bus or Universal Asynchronous Receiver Transmitter (UART) bus. As shown in FIG. 1, based on the operating mode of double-channel SPI, there are 4 lines mainly applied between the master equipment 100 (i.e., SPI apparatus) and the slave equipment (SALVE) 200 (e.g., PDA) and including: Serial Peripheral Interface Clock (SPICLK), Serial Peripheral Interface Master In/Slave Out (SPIMISO), Serial Peripheral Interface Master Out/Slave In (SPIMOSI), and Serial Peripheral Interface Chip Select (SPICS) which is enabled on low level.

A Secure Digital Input/Output (SDIO) interface is a socket of a SDIO card. A SDIO card is completely compatible with a Secure Digital (SD) card in terms of aspects such as mechanism, electric characteristics, signal and software. Normally, the SDIO interface supports 1-bit SD transmission mode and 4-bit SD transmission mode. Taking the 4-bit SD transmission mode as an example, as shown in FIG. 2, there are 6 signal lines mainly applied between the master equipment 100 (i.e., SDIO device) and the slave equipment 200 (e.g., PDA) and including: Clock(CLK) signal line, Command(CMD) line, and four data lines, i.e., DAT [3:0], wherein the CMD line and the data lines all are bidirectional signal lines.

It is a developing trend that an apparatus can support multiple interface specifications. These days, many apparatuses are provided with sockets corresponding to more than one interface device. For example, a PDA is provided with sockets corresponding to a SDIO interface device and a SPI device. However, in a case that interfaces of different specifications contained on a chip are completely independent of each other, the size of the chip and the number of pins will be increased significantly, resulting in unnecessary cost.

On the other hand, in a case that a slave equipment communicates with a master equipment via a peripheral interface such as a SPI interface operating in the existing operating mode of single-channel SPI or double-channel SPI, when data on the slave equipment side is ready to be transmitted, there is no pin transmitting a signal to the master equipment such that the master equipment is notified to start receiving and transmitting data. Therefore, the continuity of data transmission is poor. Although an identical pin may be configured on a command layer to transmit signals with different purposes, the configuration of an identical pin transmitting signals with different purposes on the command layer has complexity in some extent. Meanwhile, as the identical pin is configured on the command layer to transmit signals with different purposes, transmission errors are usually inevitable which causes the slave equipment hardly to be enabled.

Furthermore, the data throughput in the existing operating modes of single-channel SPI and double-channel SPI is relatively small, such that the requirement for transmitting data with large traffic is difficult to be satisfied.

### SUMMARY OF THE INVENTION

An object of the present invention is to multiplex at least two types of interfaces, such that the size and pins of a chip may be decreased.

In order to attain the above object, an embodiment of the present invention discloses a peripheral interface comprising one or more pins for multiplexing at least two types of interfaces, wherein the pins transmit interface signals corresponding to an interface type and type-associated operating mode which are selected from those multiplexed by the pins.

Another object of the present invention is to provide a receiving apparatus for supporting the application of the above peripheral interface.

In order to attain the above object, another embodiment of the present invention discloses a receiving apparatus comprising: a peripheral interface for multiplexing at least two types of interfaces; a receiving module for receiving an instruction signal from a user; a selecting module connected with the receiving module for selecting an interface type and type-associated operating mode which correspond to an external device to be connected, in accordance with the instruction signal received by the receiving module; and a controlling module connected with the selecting module and the peripheral interface for controlling the peripheral interface to communicate with the external device via at least one interface signal corresponding to the interface type and type-associated operating mode selected by the selecting module.

Another object of the present invention is to provide a data communication method for supporting the application of the above receiving apparatus.

In order to obtain the above object, another embodiment of the present invention discloses a data communication method comprising steps of: S1, receiving an instruction signal from a user by a receiving apparatus which comprise a peripheral interface for multiplexing at least two types of interfaces; S2, selecting an interface type and type-associated operating mode by the receiving apparatus, which are corresponding to an external device to be connected with the receiving apparatus, in accordance with the instruction signal; and S3, communicating at least one interface signal which corresponds to the selected interface type and type-associated operating mode, with the external device by the receiving apparatus via the peripheral interface.

The above embodiments of the present invention have advantageous effects as follows:

For the case that various types of interfaces may be supported, the present invention proposes a peripheral interface that can multiplex a plurality of interfaces. According to an instruction signal from a user, the receiving apparatus of the present invention selects an interface type and type-associated operating mode which are in accordance with an external device to be connected, and controls the peripheral interface of the present invention to communicate with the external device via at least one interface signal corresponding to the selected interface type and type-associated operating mode. In this way, it achieves the multiplexing of interfaces of various types, and thereby the size and pins of the chip can be reduced. At the same time, unnecessary cost can be avoided.

With an example that the peripheral interface of the present invention is a Mobile Multimedia Interface System (MMIS) interface that multiplexes SPI, SDIO interface, and Digital Video Broadcasting Transmission Socket (DVB-TS), Table 1 shows the performance of the MMIS interface. As shown in the Table 1, the SPI, SDIO interface, and DVB-TS are multiplexed together effectively. As the Table 1 shows the likely lowest efficiency of the MMIS interface in each one of the operating modes which supports 16-bit and 32-bit transmission mode, and the data transmission efficiency for these operating modes is relatively high.

TABLE 1

| MMIS | | Connect with | | |
|---|---|---|---|---|
| Operating mode | | SPI/SDIO interface device | Performance | Efficiency |
| Operating | 1-1 | Compatible with single-channel | Maximum | 50% for unidirection |
| mode 1 | | SPI interface device | 13.5 Mbit/s | |
| | 1-2 | Compatible with single-channel | Maximum | 50% for unidirection |
| | | SDIO interface device (normal | 13.5 Mbit/s | |
| | | device e.g., memory card) | | |
| Operating mode 2 | | Compatible with double-channel | Maximum | 50% for bi-direction |
| | | SPI interface device (e.g., AP, | 13.5 Mbit/s | |
| | | EEPRO and so on) | | |
| Operating | 3-1 | Compatible with four-channel | Maximum | 50% for unidirection |
| mode 3 | | SPI interface device | 54 Mbit/s | |
| | 3-2 | Compatible with four-channel | Maximum | 50% for unidirection |
| | | SDIO interface device | 54 Mbit/s | |

| | | | |
|---|---|---|---|
| Operating mode 4 | Compatible with DVB-TS | Maximum | 100% |
| | interface device | 108 Mbit/s | |

At the same time, another object of the present invention is to raise the data throughput of peripheral interface, such that the requirement for transmitting data with great flow may be satisfied.

In order to attain the above object, another embodiment of the present invention discloses a preferable peripheral interface of the above, wherein the types of the interfaces multiplexed by the pins of the peripheral interface include at least two selected from a group including SPI, SDIO interface, and DVB-TS; the type-associated operating modes of the SPI include single-channel, double-channel, and four-channel SPI; the type-associated operating modes of the SDIO interface include single-channel and four-channel SDIO interface; the type-associated operating modes of the DVB-TS include DVB-TS; and among the interfaces multiplexed by the peripheral interface (e.g., a MMIS interface), respective type-associated operating modes of the SPI, the SDIO interface and the DVB-TS are multiplexed.

By providing the operating modes of four-channel SPI and four-channel SDIO interface, the present invention can raise the data throughput of the peripheral interface effectively. For example, as shown in the Table 1, while the peripheral interface is operating in the operating mode of four-channel SPI, the data rate thereof rises to 54 Mb/s, and it is three times higher than that of the operating mode of double-channel SPI.

It is appreciated for a skilled in the art that the feature of the operating mode of four-channel SPI and four-channel SDIO interface can be supplemented into the receiving apparatus and the data communication method of the present invention too, and the same advantageous effect can be obtained. No more explanation of the supplementation is repeated hereafter.

In addition, another object of the present invention is to improve the continuity of data transmission, such that the transmission error and the situation that the device unable to start can be avoided as possible.

In order to attain the above object, another embodiment of the present invention discloses a peripheral interface provided on a receiving apparatus and provided with a plurality of pins (such as a pin for transmitting data, a pin for transmitting clock signal, a pin for transmitting chip select signal, and the like) for communicating with an external device, wherein one of the pins is defined as a pin for transmitting an interrupt signal to the external device, such that the external device is notified of state information indicating whether data in the pins is ready or not to be transmitted.

By provided with a special pin for transmitting the interrupt signal, the peripheral interface of the present invention can timely notify the corresponding external device with the state information indicating whether data in the receiving apparatus is ready or not to be transmitted. For example, when the pin for transmitting data is ready to receive/transmit data, the interrupt signal is sent to the external device, such that the external device can be notified that the local device has finished preparation for receiving/transmitting data.

For the above peripheral interface of the present invention, because a physical pin is adopted to transmit the interrupt signal, the continuity of the data transmission can be improved thereby. On the other hand, as it does not need to configure an identical pin on the command layer to transmit signals of different functions, not only the complexity of the command layer design but also the possibility of data transmission error can be decreased.

It is appreciated for a skilled in the art that the feature of special pin for transmitting interrupt signal can be supplemented into the receiving apparatus and the data communication method of the present invention too, and the same advantageous effect can be obtained. Similarly, No more explanation of the supplementation is repeated hereafter.

### BRIEF DESCRIPTION OF THE DRAWINGS

FIG. 1 shows the connection relation between a master equipment and a slave equipment in the operating mode of known SPI;

FIG. 2 shows the connection relation between a master equipment and a slave equipment in the operating mode of known SDIO interface;

FIG. 3 shows the structure of the receiving apparatus according to an embodiment of the present invention;

FIG. 4 shows the connection relation between a master equipment and a slave equipment based on the peripheral interface (e.g., a MMIS interface) according to an embodiment of the present invention;

FIG. 5 shows the flow charts of the method according to an embodiment of the present invention;

FIG. 6 shows the connection relation between a master equipment and a slave equipment according to the first embodiment of the present invention, wherein operating modes of single-channel SPI and single-channel SDIO interface are multiplexed;

FIG. 7 shows the connection relation between a master equipment and a slave equipment according to the second embodiment of the present invention, wherein an operating mode of double-channel SPI is applied;

FIG. 8 shows the connection relation between a master equipment and a slave equipment according to the third embodiment of the present invention, wherein operating mode of four-channel SPI and four-channel SDIO interface are multiplexed; and

FIG. 9 shows the connection relation between a master equipment and a slave equipment according to the fourth embodiment of the present invention, wherein an operating mode of DVB-TS is applied.

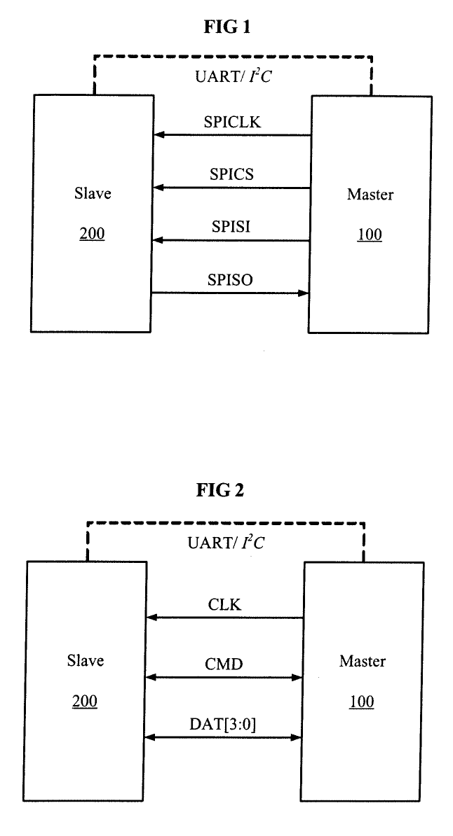

### DETAILED DESCRIPTION OF THE INVENTION

For a case that a plurality of interfaces are supported, in order to multiplex various types of interfaces such that the size of the chip and the number of pins can be reduced to avoid unnecessary cost, the present invention discloses a peripheral interface. The peripheral interface comprises one or more pins for multiplexing at least two types of interfaces such as SPI, SDIO interface, and DVB-TS, wherein the pins of the peripheral interface transmit at least one interface signal corresponding to an interface type and type-associated operating mode which are selected from those multiplexed by the pins.

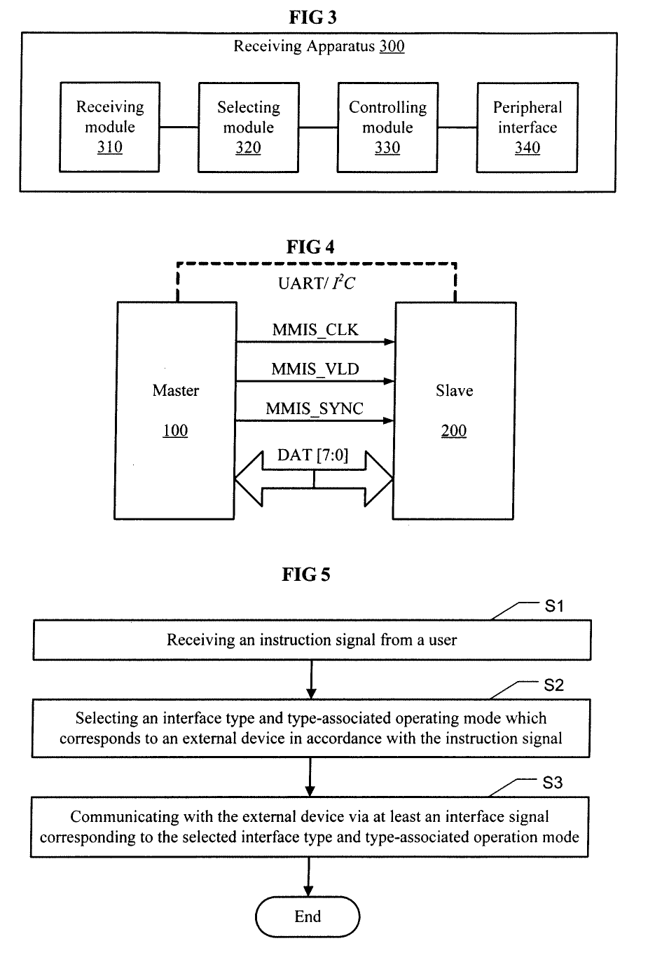

The present invention also discloses a receiving apparatus mainly used as a slave equipment 200. As shown in FIG. 3, the receiving apparatus comprises a receiving module 310, a selecting module 320, a controlling module 330, and a peripheral interface 340 which are connected in order.

The peripheral interface 340 (e.g., a MMIS interface) multiplexes at least two types of interfaces. For example, the above peripheral interface provided by the present invention may be used as the peripheral interface 340. Furthermore, the types of the interfaces multiplexed by the peripheral interface 340 include at least two selected from a group including SPI, SDIO interface, and DVB-TS.

The receiving module 310 receives an instruction signal from a user. For example, in a case that the receiving apparatus 300 is a mobile phone, while a user selects “connect with SDIO interface device” in the operation system menu of the mobile phone, the receiving module 310 receives the instruction signal for connecting with a SDIO interface device.

The selecting module 320 selects an interface type and type-associated operating mode, which are corresponding to an external device to be connected with the receiving apparatus 300, in accordance with the instruction signal received by the receiving module 310. For example, in a case that the external device to be connected with the receiving apparatus 300 is a SDIO interface device, the selecting module 320 may, according to the instruction signal, determine that the selected interface type is the SDIO interface and the selected type-associated operating mode is the single-channel or four-channel SDIO interface.

The controlling module 330 controls the peripheral interface 340, such that the peripheral interface 340 communicates with the external device via interface signal(s) corresponding to the interface type and type-associated operating mode selected by the selecting module 320.

Taking an example that the above peripheral interface is embodied as a MMIS interface, the connection relation in the operating mode of DVB-TS between the master equipment 100 (e.g., an external device such as a SPI interface device, SDIO interface device, DVB-TS interface device and so on) and the slave equipment 200 (e.g., the receiving apparatus 300 of the present invention) is shown in FIG. 4. As shown in FIG. 4, the pins connected between these two equipments include: MMIS_CLK pin of the MMIS interface, MMIS_VLD pin of the MMIS interface, MMIS_SYNC pin of the MMIS interface (optional), and other pins MMIS_D0˜MMIS_D7 of the MMIS interface for transmitting data.

Herein, the present invention also discloses a data communication method, as shown in FIG. 5, comprising steps of:

S1, receiving an instruction signal from a user by a receiving apparatus which comprises a peripheral interface for multiplexing at least two types of interfaces (e.g., the receiving apparatus 300 of the present invention comprises the peripheral interface 340);

S2, selecting an interface type and type-associated operating mode by the receiving apparatus, which are corresponding to an external device to be connected, in accordance with the instruction signal, wherein the interface types corresponding to the external device to be connected may be SPI, SDIO interface, and DVB-TS interface; and

S3, communicating at least one interface signal which corresponds to the selected interface type and type-associated operating mode, with the external device by the receiving apparatus via the peripheral interface.

For the peripheral interface, the receiving apparatus, and the data communication method as mentioned above, preferably, the type-associated operating modes of the SPI include single-channel, double-channel, and four-channel SPI; the type-associated operating modes of the SDIO interface include single-channel and four-channel SDIO interface; the type-associated operating modes of the DVB-TS include DVB-TS; and wherein among the interface multiplexed by the peripheral interface (e.g., a MMIS interface), respective type-associated operating modes of the SPI, the SDIO interface, and the DVB-TS are multiplexed. For example, the peripheral interface (e.g., a MMIS interface) may multiplex the operating modes of single-channel SPI and single-channel SDIO interface, the operating modes of single-channel SPI and four-channel SDIO interface, the operating modes of single-channel SPI and DVB-TS, and so on.

More preferably, when the selected interface type is the SPI or SDIO interface, corresponding interface signals include an interrupt signal, such that a corresponding external device (e.g., the master equipment 100) can be notified of the state information indicating whether data in the receiving apparatus 300 is ready or not to be transmitted.

Further preferably, in a case that the peripheral interface 340 is embodied as a MMIS interface, when the selected interface type is the SPI and the selected type-associated operating mode is the four-channel SPI, corresponding interface signals are defined in a manner as follows:

a clock signal is transmitted by a MMIS_CLK pin of the MMIS interface;

data of the fourth channel is transmitted by a MMIS_VLD pin of the MMIS interface;

data of the first channel is transmitted by a MMIS_D0 pin of the MMIS interface;

data of the second channel is transmitted by a MMIS_D1 pin of the MMIS interface;

data of the third channel is transmitted by a MMIS_D2 pin of the MMIS interface;

a chip select signal is transmitted by a MMIS_D3 pin of the MMIS interface; and/or

the interrupt signal as mentioned above is transmitted by a MMIS_D4 pin of the MMIS interface.

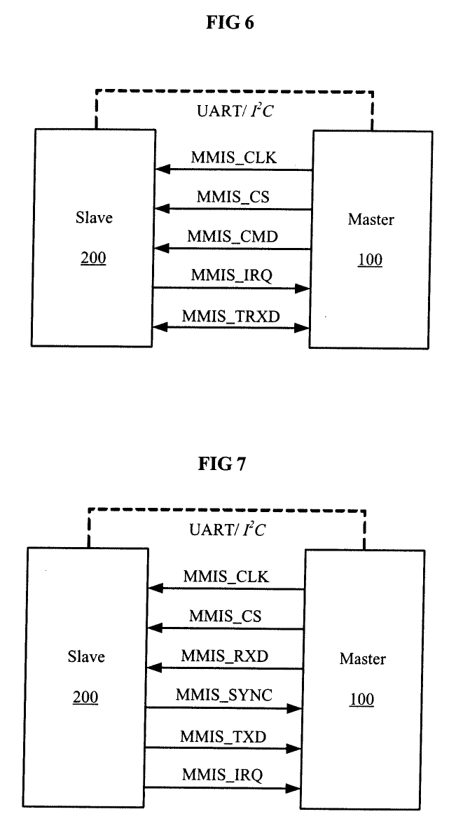

Thereafter, assuming that the peripheral interface 300 is a MMIS interface, four embodiments of the present invention, in which different operating modes associated with different interface types may be applied, will be described with reference to FIGS. 6˜9. In particular, the multiplex relation and the logic relation among the pins of the MMIS interface are detailed.

### THE FIRST EMBODIMENT

In a case that the MMIS interface is operating in an operating mode of single-channel SPI or single-channel SDIO interface, FIG. 6 shows the connection relation between the master equipment 100 and the slave equipment 200. As shown in FIG. 6, pins connected between these two comprise: MMIS_CLK pin of the MMIS interface, MMIS_D3 (MMIS_CS) pin of the MMIS interface, MMIS_VLD (MMIS_CMD/MMIS_RXD) pin of the MMIS interface, MMIS_D1 (MMIS_IRQ) pin of the MMIS interface, and MMIS_D0 (MMIS_TRXD) pin of the MMIS interface.

In detail, when the MMIS interface is operating in the operating mode of single-channel SPI, as shown in Table 2, the corresponding interface signals transmitted by the pins of the MMIS interface are defined in a manner as follows:

a clock signal is transmitted by the MMIS_CLK pin of the MMIS interface;

an indication signal of multiplexed frame header is transmitted by the MMIS_SYNC pin of the MMIS interface;

data is transmitted bidirectionally by the MMIS_D0 (MMIS_TKXD/MMIS_TXD) pin of the MMIS interface;

an interrupt signal is transmitted by the MMIS_D1 (MMIS_IRQ) pin of the MMIS interface; and

a chip select signal is transmitted by the MMIS_D3 (MMIS_CS) pin of the MMIS interface.

In addition, when the MMIS interface is operating in the operating mode of single-channel SDIO interface, as shown in Table 2, the corresponding interface signals transmitted by the pins of the MMIS interface are defined in a manner as follows:

a clock signal is transmitted by the MMIS_CLK pin of the MMIS interface;

a command signal is transmitted by the MMIS_VLD (MMIS_CMD/MMIC_RXD) pin of the MMIS interface;

an indication signal of multiplexed frame header is transmitted by the MMIS_SYNC pin of the MMIS interface;

data is transmitted bidirectionally by the MMIS_D0 (MMIS_TRXD/MMIS_TXD) pin of the MMIS interface;

an interrupt signal is transmitted by the MMIS_D1 (MMIS_IRQ) pin of the MMIS interface; and

a read wait signal is transmitted by the MMIS_D2 (MMIS_RW) pin of the MMIS interface.

TABLE 2

| MMIS Pin | MMIS Operating mode | | | |
|---|---|---|---|---|
| Name | Single-channel SPI | | Single-channel SDIO interface | |
| MMIS_CLK | MMIS_CLK | clock | MMIS_CLK | clock |
| MMIS_VLD | | | MMIS_CMD | command |
| (MMIS_CMD/ | | | | |
| MMIS_RXD) | | | | |
| MMIS_SYNC | MMIS_SYNC | indication of | MMIS_SYNC | indication of |
| | | multiplexed | | multiplexed |
| | | frame header | | frame header |
| | | (optional) | | (optional) |
| MMIS_D0 | MMIS_TRXD | bidirectional data | MMIS_TRXD | bidirectional data |
| (MMIS_TRXD/ | | | | |
| MMIS_TXD) | | | | |
| MMIS_D1 | MMIS_IRQ | interrupt | MMIS_IRQ | interrupt |
| (MMIS_IRQ) | | | | |
| MMIS_D2 | | | RW | read wait |
| (MMIS_RW) | | | | (optional) |
| MMIS_D3 | MMIS_CS | chip select | | |
| (MMIS_CS) | | | | |
| MMIS_D4 | | | | |
| MMIS_D5 | | | | |
| MMIS_D6 | | | | |
| MMIS_D7 | | | | |

It can be seen Table 2, the MMIS_CLK pin, the MMIS_SYNC pin, the MMIS_D0 (MMIS_TRXD/MMIS_TXD) pin, and the MMIS_DL (MMIS_IRQ) pin of the MMIS interface are multiplexed in the operating modes of single-channel SPI and single-channel SDIO interface.

In addition, as mentioned above, in each of these two operating modes of single-channel SPI and single-channel SDIO interface, a pin may be assigned for transmitting an interrupt signal, such that the state information indicating whether data is ready or not to be transmitted can be sent to a corresponding external device. For example, when the pin for transmitting data is ready to transmit data, the slave equipment 200 sends the interrupt signal to the master equipment 100, and then the master equipment 100 can be notified of the state information indicating the slave equipment 200 has finished the preparation for transmitting data.

Furthermore, when the slave equipment 200 communicates with the master equipment 100 by the MMIS interface which operates in the operating mode of single-channel SPI and includes one or more pins for transmitting the interruption signal, the logic relation among the pins of the MMIS interface is detailed as follows.

When the MMIS_D0 (MMIS_TRXD/MMIS_TXD) pin for transmitting data bidirectionally is ready to transmit data, the MMIS_DL (MMIS_IRQ) pin for transmitting the interrupt signal sends the interrupt signal to the master equipment 100.

After receiving the interrupt signal from the MMIS_D1 (MMIS_IRQ) pin for transmitting the interrupt signal, the master equipment 100 transmits the clock signal, the chip select signal, and the command signal.

Then the MMIS_CLK pin for transmitting the clock signal, the MMIS_D3 (MMIS_CS) pin for transmitting the chip select signal, and the MMIS_D0 (MMIS_TRXD/MMIS_TXD) pin for transmitting data bidirectionally receive the clock signal, the chip select signal, and the command signal from the master equipment 100 respectively.

After the clock signal, the chip select signal, and the command signal have been received by the slave equipment 200, the MMIS_D0 (MMIS_TRXD/MMIS_TXD) pin for transmitting data bidirectionally starts to communicate data with the master equipment 100.

In this way, by adding the MMIS_D1 (MMIS_IRQ) pin to transmit the interrupt signal, once the MMIS_D0 (MMIS_TRXD/MMIS_TXD) pin for transmitting data bidirectionally is ready to receive/transmit data, the slave equipment 200 may send an interrupt signal to a corresponding external device (e.g., the master equipment 100), such that the external device can be notified that the local device has finished the preparation for receiving/transmitting data. Therefore, it can ensure the startup signal of receiving/transmitting data (i.e., the interrupt signal) being notified to the external device timely.

### THE SECOND EMBODIMENT

In a case that the MMIS interface is operating in an operating mode of double-channel SPI, FIG. 7 shows the connection relation between the master equipment 100 and the slave equipment 200. As shown in FIG. 7, pins connected between these two comprise: MMIS_CLK pin of the MMIS interface, MMIS_D3 (MMIS_CS) pin of the MMIS interface, MMIS_VLD (MMIS_CMD/MMIC_RXD) pin of the MMIS interface, MMIS_SYNC pin of the MMIS interface, MMIS_D0 (MMIS_TRXD/MMIS_TXD) pin of the MMIS interface, and MMIS_D1 (MMIS_IRQ) pin of the MMIS interface.

In detail, when the MMIS interface is operating in the operating mode of double-channel SPI, as shown in Table 3, the corresponding interface signals transmitted by the pins of the MMIS interface are defined as follows:

a clock signal is transmitted by the MMIS_CLK pin of the MMIS interface;

data is inputted by the MMIS_VLD (MMIS_CMD/MMIC_RXD) pin of the MMIS interface;

an instruction signal of multiplexed frame header is transmitted by the MMIS_SYNC pin of the MMIS interface;

data is outputted by the MMIS_D0 (MMIS_TRXD/MMIS_TXD) pin of the MMIS interface;

an interrupt signal is transmitted by the MMIS_D1 (MMIS_IRQ) pin of the MMIS interface; and

a chip select signal is transmitted by the MMIS_D3 (MMIS_CS) pin of the MMIS interface.

TABLE 3

| | MMIS Operating | |
|---|---|---|
| MMIS Pin Name | Mode (double-channel SPI) | |
| MMIS_CLK | MMIS_CLK | Clock |
| MMIS_VLD | MMIS_RXD | data input |
| (MMIS_CMD/MMIS_RXD) | | |
| MMIS_SYNC | MMIS_SYNC | indication of multiplexed |
| | | frame header (optional) |
| MMIS_D0 (MMIS_TRXD/ | MMIS_TXD | data output |
| MMIS_TXD) | | |
| MMIS_D1 (MMIS_IRQ) | MMIS_IRQ | Interrupt |
| MMIS_D2 (MMIS_RW) | | |
| MMIS_D3 (MMIS_CS) | MMIS_CS | chip select |
| MMIS_D4 | | |
| MMIS_D5 | | |
| MMIS_D6 | | |
| MMIS_D7 | | |

The multiplex relation among pins of the MMIS interface in the operating mode of double-channel SPI and single-channel SDIO interface may be figured out by comparing Table 3 with Table 2 which shows the operating mode of single-channel SDIO interface.

Similarly, as mentioned above, the operating mode of double-channel SPI also specifies a pin for transmitting the interrupt signal, which may obtain the same advantageous effect as that of the operating modes of single-channel SPI or single-channel SDIO interface.

Furthermore, when the slave equipment 200 communicates with the master equipment 100 by the MMIS interface which operates in the operating mode of double-channel SPI and includes a pin for transmitting the interrupt signal, the logic relation among the pins of the MMIS interface is detailed as follows.

When the MMIS_VLD (MMIS_CMD/MMIS_RXD) pin for inputting data and the MMIS_D0 (MMIS_TRXD/MMIS_TXD) pin for outputting data are ready to receive/transmit data, the MMIS_D1 (MMIS_IRQ) pin for transmitting interrupt signal sends an interrupt signal to the external device (e.g. master equipment 100). After receiving the interrupt signal from the MMIS_D1 (MMIS_IRQ) pin for transmitting the interrupt signal, the master equipment 100 transmits the clock signal, the chip select signal, and the command signal.

Then the MMIS_CLK pin for transmitting the clock signal, the MMIS_D3 (MMIS_CS) pin for transmitting the chip select signal, and the MMIS_VLD (MMIS_CMD/MMIS_RXD) pin for inputting data receive the clock signal, the chip select signal, and the command signal from the master equipment 100 respectively.

After the clock signal, the chip select signal, and the command signal have been received by the slave equipment 200, the MMIS_D0 (MMIS_TRXD/MMIS_TXD) pin for outputting data starts to transmit data to the master equipment 100.

In this way, by adding the MMIS_D1 (MMIS_IRQ) pin to transmit interrupt signal, once the MMIS_VLD (MMIS_CMD/MMIS_RXD) pin for inputting data and the MMIS_D0 (MMIS_TRXD/MMIS_TXD) pin for outputting data are ready to receive/transmit data, the slave equipment 200 may send an interrupt signal to a corresponding external device (e.g., the master equipment 100), such that the external device can be notified that the local device has finished the preparation for receiving/transmitting data. Therefore, it can ensure the startup signal of receiving/transmitting data (i.e., the interrupt signal) being notified to the external device timely.

### THE THIRD EMBODIMENT

Due to the relatively small data throughput of the operating modes of single-channel and double-channel SPI, the present invention proposes an operating mode of four-channel which comprises four pins for receiving/transmitting data.

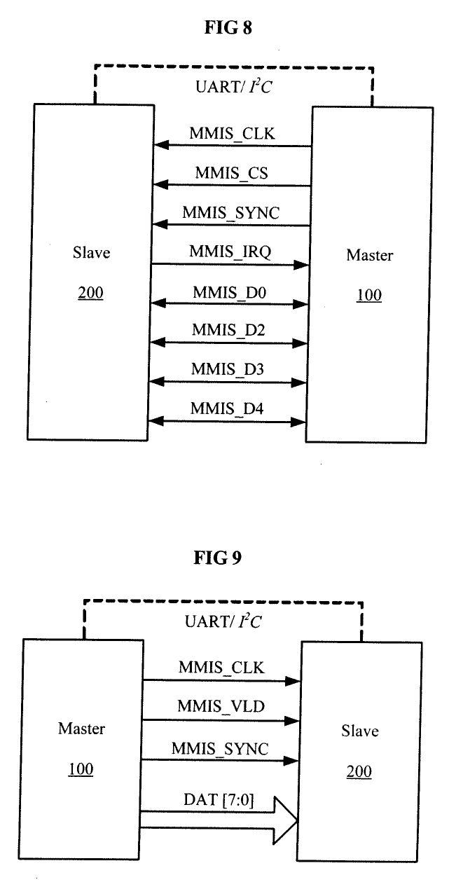

In a case that the MMIS interface is operating in the operating mode of four-channel SPI or four-channel SDIO interface, the connection relation between the master equipment 100 and the slave equipment 200 is shown in FIG. 8. As shown in FIG. 8, pins connected between these two comprise: MMIS_CLK pin of the MMIS interface, MMIS_VLD (MMIS_CMD/MMIC_RXD) pin of the MMIS interface, MMIS_SYNC pin of the MMIS interface, MMIS_D1 (MMIS_IRQ) pin of the MMIS interface, MMIS_D0 (MMIS_TRXD/MMIS_TXD) pin of the MMIS interface, MMIS_D2 (MMIS_RW) pin of the MMIS interface, MMIS_D3 (MMIS_CS) pin of the MMIS interface, and MMIS_D4 (MMIS_IRQ) pin of the MMIS interface.

In detail, when the MMIS interface is operating in the operating mode of four-channel SPI, as shown in Table 4, the corresponding interface signals transmitted by the pins of the MMIS interface are defined in a manner as follows:

a clock signal is transmitted by the MMIS_CLK pin of the MMIS interface;

data of the fourth channel is transmitted by the MMIS_VLD (MMIS_CMD/MMIC_RXD) pin of the MMIS interface;

an instruction signal of multiplexed frame header is transmitted by the MMIS_SYNC pin of the MMIS interface;

data of the first channel is transmitted by the MMIS_D0 (MMIS_TRXD/MMIS_TXD) pin of the MMIS interface;

data of the second channel is transmitted by the MMIS_D1 (MMIS_IRQ) pin of the MMIS interface;

data of the third channel is transmitted by the MMIS_D2 (MMIS_RW) pin of the MMIS interface;

a chip select signal is transmitted by the MMIS_D3 (MMIS_CS) pin of the MMIS interface;

an interrupt signal is transmitted by the MMIS_D4 (MMIS_IRQ) pin of the MMIS interface; and

the MMIS_D5 pin, MMIS_D6 pin and MMIS_D7 pin of the MMIS interface are idle.

In addition, when the MMIS interface is operating in the operating mode of four-channel SDIO interface, as shown in Table 4, the corresponding interface signals transmitted by the pins of the MMIS interface are defined in a manner as follows:

a clock signal is transmitted by the MMIS_CLK pin of the MMIS interface;

a command instruction is transmitted by the MMIS_VLD (MMIS_CMD/MMIC_RXD) pin of the MMIS interface;

an instruction signal of multiplexed frame header is transmitted by the MMIS_SYNC pin of the MMIS interface;

data of the first channel is transmitted by the MMIS_D0 (MMIS_TRXD/MMIS_TXD) pin of the MMIS interface;

data of the second channel is transmitted by the MMIS_D1 (MMIS_IRQ) pin of the MMIS interface;

data of the third channel or a read wait signal is transmitted by the MMIS_D2 (MMIS_RW) pin of the MMIS interface;

data of the fourth channel is transmitted by the MMIS_D3 (MMIS_CS) pin of the MMIS interface;

an interrupt signal is transmitted by the MMIS_D4 (MMIS_IRQ) pin of the MMIS interface; and

the MMIS_D5 pin, MMIS_D6 pin and MMIS_D7 pin of the MMIS interface are idle.

TABLE 4

| | MMIS Operating Modes | | | |
|---|---|---|---|---|
| | | | Four-channel SDIO | |
| MMIS Pin Name | Four-channel SPI | | interface | |
| MMIS_CLK | MMIS_CLK | clock | MMIS_CLK | clock |
| MMIS_VLD | MMIS_D3 | data of the | MMIS_CMD | |
| (MMIS_CMD/MMIS_RXD) | | fourth | | |
| | | channel | | |
| MMIS_SYNC | MMIS_SYNC | indication | MMIS_SYNC | indication |
| | | of | | of |
| | | multiplexed | | multiplexed |
| | | frame | | frame |
| | | header | | header |
| | | (optional) | | (optional) |
| MMIS_D0 (MMIS_TRXD/ | MMIS_D0 | data of the | MMIS_D0 | data of the |
| MMIS_TXD) | | first | | first |
| | | channel | | channel |
| MMIS_D1 | MMIS_D1 | data of the | MMIS_D1 | data of the |
| | | second | | second |
| | | channel | | channel |
| MMIS_D2 (MMIS_RW) | MMIS_D2 | data of the | MMIS_D2 | data of the |
| | | third | (MMIS_RW) | third |
| | | channel | | channel or |
| | | | | read wait |
| | | | | signal |
| MMIS_D3 (MMIS_CS) | MMIS_CS | chip select | MMIS_D3 | data of the |
| | | | | fourth |
| | | | | channel |
| MMIS_D4 (MMIS_IRQ) | MMIS_IRQ | interrupt | MMIS_IRQ | interrupt |
| | | signal | | signal |
| MMIS_D5 | | | | |
| MMIS_D6 | | | | |
| MMIS_D7 | | | | |

It can be seen from Table 4, when the MMIS interface is operating in the operating mode of four-channel SPI and four-channel SDIO interface, all the pins of the MMIS interface are multiplexed, except that the MMIS_D5 pin, MMIS_D6 pin and MMIS_D7 pin are idle.

Obviously, by comparing Table 4 with Table 3 or Table 2, other multiplex relation between these operating modes can be figured out easily.

Similarly, a pin for transmitting an interrupt signal may be assigned in each of the operating modes of four-channel SPI and four-channel SDIO interface, which may obtain the same advantageous effect as that of the operating modes of single-channel or double-channel.

Furthermore, when the slave equipment 200 communicates with the master equipment 100 by the MMIS interface which operates in the operating mode of four-channel SPI and includes a pin for transmitting the interrupt signal, the logic relation among the pins of the MMIS interface is detailed as follows.

When the MMIS_D0 (MMIS_TRXD/MMIS_TXD) pin for transmitting data of the first channel, the MMIS_D1 pin for transmitting data of the second channel, the MMIS_D2 (MMIS_RW) pin for transmitting data of the third channel, the MMIS_VLD (MMIS_CMD/MMIS_RXD) pin for transmitting data of the fourth channel are ready to receive/transmit data, the MMIS_D4 (MMIS_IRQ) pin for transmitting the interrupt signal sends the interrupt signal to the external device (e.g., master equipment 100).

After receiving the interrupt signal from the MMIS_D4 (MMIS_IRQ) pin for transmitting the interrupt signal, the master equipment 100 transmits the clock signal, the chip select signal, and the command signal.

Then the MMIS_CLK pin for transmitting clock signal and the MMIS_D3 (MMIS_CS) pin for transmitting chip select signal receive the clock signal and the chip select signal from the master equipment 100 respectively, while the MMIS_D0 (MMIS_TRXD/MMIS_TXD) pin and the MMIS_D1 pin for inputting data receive the command signal from the master equipment 100.

After the clock signal, the chip select signal, and the command signal have been received by the slave equipment 200, the MMIS_D2 (MMIS_RW) pin and the MMIS_VLD (MMIS_CMD/MMIS_RXD) pin for outputting data starts to transmit data to the master equipment 100 in parallel.

It can be seen from the above, in contrast with the operating mode of double-channel SPI, the operating mode of four-channel SPI adds a pin for receiving data and a pin for transmitting data, such that the data throughout of corresponding MMIS interface can be increased effectively. Of course, based on the above description, a person skilled in the art may understand that the operating mode of four-channel should not be limited to comprise four pins for transmitting data unidirectionally (e.g., two pins for receiving data and the other two pins for sending data as above), but also may comprise four pins all for transmitting data bidirectionally.

Incidentally, similarly to the above embodiments, by adding the MMIS_D4 (MMIS_IRQ) pin to transmit an interrupt signal, once the MMIS_D0 (MMIS_TRXD/MMIS_TXD) pin, the MMIS_D1 pin, the MMIS_D2 (MMIS_RW) pin, and the MMIS_VLD (MMIS_CMD/MMIS_RXD) pin for receiving/transmitting data are ready to receive/transmit data, the slave equipment 200 may send an interrupt signal to a corresponding external device (e.g., the master equipment 100) such that the external device can be notified that the local device has finished the preparation for receiving/transmitting data. Therefore, it can ensure the startup signal of receiving/transmitting data (i.e., the interrupt signal) being sent to the external device timely.

### THE FOURTH EMBODIMENT

In a case that the MMIS interface is operating in the operating mode of DVB-TS, the connection relation between the master equipment 100 and the slave equipment 200 is shown in FIG. 9. As shown in FIG. 9, pins connected between these two comprise: MMIS_CLK pin of the MMIS interface, MMIS_VLD (MMIS_CMD/MMIC_RXD) pin of the MMIS interface, MMIS_SYNC pin of the MMIS interface, and eight pins MMIS_D0˜MMIS_D7 of the MMIS interface for transmitting data of eight channels.

In detail, when the MMIS interface is operating in the operating mode of DVB-TS, as shown in Table 5, the corresponding interface signals transmitted by the pins of the MMIS interface are defined in a manner as follows:

a clock signal is transmitted by the MMIS_CLK pin of the MMIS interface;

an enable signal of valid data is transmitted by the MMIS_VLD (MMIS_CMD/MMIC_RXD) pin of the MMIS interface;

an indication signal of synchronization is transmitted by the MMIS_SYNC pin of the MMIS interface;

data of the first channel is transmitted by the MMIS_D0 (MMIS_TRXD/MMIS_TXD) pin of the MMIS interface;

data of the second channel is transmitted by the MMIS_D1 (MMIS_IRQ) pin of the MMIS interface;

data of the third channel is transmitted by the MMIS_D2 (MMIS_RW) pin of the MMIS interface;

data of the fourth channel is transmitted by the MMIS_D3 (MMIS_CS) pin of the MMIS interface;

data of the fifth channel is transmitted by the MMIS_D4 pin of the MMIS interface;

data of the sixth channel is transmitted by the MMIS_D5 pin of the MMIS interface;

data of the seventh channel is transmitted by the MMIS_D6 pin of the MMIS interface; and

data of the eighth channel is transmitted by the MMIS_D7 pin of the MMIS interface.

TABLE 5

| MMIS Pin Name | MMIS Operating mode (DVB-TS) | |
|---|---|---|
| MMIS_CLK | MMIS_CLK | clock signal |
| MMIS_VLD | MMIS_VLD | enable signal of valid data |
| (MMIS_CMD/ | | |
| MMIS_RXD) | | |
| MMIS_SYNC | MMIS_SYNC | indication signal for |
| | | synchronization (optional) |
| MMIS_D0 | MMIS_D0 | data of the first channel |
| (MMIS_TRXD/ | | |
| MMIS_TXD) | | |
| MMIS_D1 (MMIS_IRQ) | MMIS_D1 | data of the second channel |
| MMIS_D2 (MMIS_RW) | MMIS_D2 | data of the third channel |
| MMIS_D3 (MMIS_CS) | MMIS_D3 | data of the fourth channel |
| MMIS_D4 | MMIS_D4 | data of the fifth channel |
| MMIS_D5 | MMIS_D5 | data of the sixth channel |
| MMIS_D6 | MMIS_D6 | data of the seventh channel |
| MMIS_D7 | MMIS_D7 | data of the eighth channel |

Obviously, by comparing Table 5 with Table 4, Table 3 or Table 2, other multiplex relation between these operating modes can be figured out easily.

### INDUSTRIAL APPLICABILITY

An application example will be introduced for illustrating the present invention more concretely.

A user inserts a four-channel SDIO mobile multimedia card into a SDIO socket provided on the receiving apparatus of the present invention (e.g., a mobile phone), and the card connects with the MMIS interface in the mobile phone. The user selects “connect with SDIO interface device” on the operation system menu of the mobile phone. The receiving module within the mobile phone receives the user's instruction “connect with SDIO interface device” from the operation system of the mobile phone. Afterwards, the selecting module within the mobile phone selects an interface type (SDIO interface) and associated operating mode (four-channel SDIO interface) according to the instruction. Finally, the controlling module within the mobile phone controls the MMIS interface to communicate with the four-channel SDIO mobile multimedia card via interface signals corresponding to the selected operating mode of four-channel SDIO interface.

In conclusion, in particular of mobile multimedia technology, the velocity of the MMIS interface of the present invention varies from 167 Kb/s to 108 Mb/s, such that it can satisfies the requirement of pins and bandwidth for multimedia applications. Meanwhile, the MMIS interface is capable to directly connect with common devices provided with SPI/SDIO interface, such that the compatibility of the chip with various multimedia application processors is enhanced. In order to solve the problem of relatively small data throughput of the operating mode of double-channel SPI, the present invention proposes an operating mode of four-channel SPI and adds an interrupt control signal which is outputted from the slave equipment and inputted to the master equipment.

In other words, the peripheral interface according to the present invention supports operating modes of single-channel SPI, double-channel SPI, and four-channel SPI; and it is compatible with SDIO single-bit transmission mode (i.e., the operating mode of single-channel SDIO), SDIO four-bit transmission mode (i.e., the operating mode of four-channel SDIO), and DVB-TS interface.

Meanwhile, the receiving apparatus according to the present invention can receive configuration information from the I²C. or UART port.

The above just illustrates preferable embodiments according to the present invention, which should not be regarded as restriction on the implementations of the present invention. Instead, it should be understood that numerous other modifications and embodiments can be devised by the person skilled in the art that will fall within the spirit and scope of the principles of the disclosure, and the protection scope of the present invention should be defined by the claims.

What is claimed is:

1. A receiving apparatus comprising:
a peripheral interface for multiplexing at least two types of interfaces;
a receiving module for receiving an instruction signal from a user;
a selecting module connected with the receiving module for selecting an interface type and type-associated operating mode which correspond to an external device to be connected in accordance with the instruction signal received by the receiving module; and
a controlling module connected with the selecting module and the peripheral interface for controlling the peripheral interface to communicate with the external device via at least one interface signal corresponding to the interface type and type-associated operating mode selected by the selecting module.

2. The receiving apparatus according to claim 1, wherein the peripheral interface is a Mobile Multimedia Interface System (MMIS) interface, and the types of the interfaces multiplexed by the MMIS interface include at least two selected from a group including serial peripheral interface (SPI), secure digital input/output (SDIO) interface, and digital video broadcasting transmission socket (DVB-TS).

3. The receiving apparatus according to claim 2, wherein
the type-associated operating modes of the SPI include single-channel, double-channel, and four-channel SPI;
the type-associated operating modes of the SDIO interface include single-channel and four-channel SDIO interface;
the type-associated operating modes of the DVB-TS include DVB-TS; and wherein
among the interfaces multiplexed by the MMIS interface, respective type-associated operating modes of the SPI, the SDIO interface and the DVBTS are multiplexed.

4. The receiving apparatus according to claim 3, wherein when the interface type selected by the selecting module is the SPI or SDIO interface, corresponding interface signals include an interrupt signal.

5. The receiving apparatus according to claim 3, wherein when the interface type selected by the selecting module is the SPI and the type-associated operating mode selected by the selecting module is the four-channel SPI, corresponding interface signals are defined as
a clock signal transmitted by a MMIS_CLK pin of the MMIS interface,
data of the fourth channel transmitted by a MMIS_VLD pin of the MMIS interface,
data of the first channel transmitted by a MMIS_D0 pin of the MMIS interface,
data of the second channel transmitted by a MMIS_D1 pin of the MMIS interface,
data of the third channel transmitted by a MMIS_D2 pin of the MMIS interface, and
a chip select signal transmitted by a MMIS_D3 pin of the MMIS interface.

6. The receiving apparatus according to claim 4, wherein when the interface type selected by the selecting module is the SPI and the type-associated operating mode selected by the selecting module is the four-channel SPI, the corresponding interface signals are defined as
a clock signal transmitted by a MMIS_CLK pin of the MMIS interface,
data of the fourth channel transmitted by a MMIS_VLD pin of the MMIS interface,
data of the first channel transmitted by a MMIS_D0 pin of the MMIS interface,
data of the second channel transmitted by a MMIS_D1 pin of the MMIS interface,
data of the third channel transmitted by a MMIS_D2 pin of the MMIS interface,
a chip select signal transmitted by a MMIS_D3 pin of the MMIS interface, and
the interrupt signal transmitted by a MMIS_D4 pin of the MMIS interface.

7. A peripheral interface comprising:
one or more pins for multiplexing at least two types of interfaces; wherein
the pins transmit at least one interface signal corresponding to an interface type and type-associated operating mode which are selected from those multiplexed by the pins.

8. The peripheral interface according to claim 7, wherein the peripheral interface is a MMIS interface, and the types of the interfaces multiplexed by the pins of the peripheral interface include at least two selected from a group including SPI, SDIO interface, and DVB-TS.

9. The peripheral interface according to claim 8, wherein
the type-associated operating modes of the SPI include single-channel, double-channel, and four-channel SPI;
the type-associated operating modes of the SDIO interface include single-channel and four-channel SDIO interface;
the type-associated operating modes of the DVB-TS include DVB-TS; and wherein
among the interfaces multiplexed by the MMIS interface, respective type-associated operating modes of the SPI, the SDIO interface and the DVBTS are multiplexed.

10. The peripheral interface according to claim 9, wherein when the selected interface type is the SPI or SDIO interface, corresponding interface signals include an interrupt signal.

11. The peripheral interface according to claim 9, wherein when the selected interface type is the SPI and the selected type-associated operating mode is the four-channel SPI, corresponding interface signals are defined as
a clock signal transmitted by a MMIS_CLK pin of the MMIS interface,
data of the fourth channel transmitted by a MMIS_VLD pin of the MMIS interface,
data of the first channel transmitted by a MMIS_D0 pin of the MMIS interface,
data of the second channel transmitted by a MMIS_D1 pin of the MMIS interface,
data of the third channel transmitted by a MMIS_D2 pin of the MMIS interface, and
a chip select signal transmitted by a MMIS_D3 pin of the MMIS interface.

12. The peripheral interface according to claim 10, wherein when the selected interface type is the SPI and the selected type-associated operating mode is the four-channel SPI, corresponding interface signals are defined as
a clock signal transmitted by a MMIS_CLK pin of the MMIS interface,
data of the fourth channel transmitted by a MMIS_VLD pin of the MMIS interface,
data of the first channel transmitted by a MMIS_D0 pin of the MMIS interface,
data of the second channel transmitted by a MMIS_D1 pin of the MMIS interface,
data of the third channel transmitted by a MMIS_D2 pin of the MMIS interface,
a chip select signal transmitted by a MMIS_D3 pin of the MMIS interface, and
the interrupt signal transmitted by a MMIS_D4 pin of the MMIS interface.

13. A data communication method comprising steps of:
S1, receiving an instruction signal from a user by a receiving apparatus which comprise a peripheral interface for multiplexing at least two types of interfaces;
S2, selecting an interface type and type-associated operating mode by the receiving apparatus, which are corresponding to an external device to be connected, in accordance with the instruction signal; and
S3, communicating at least one interface signal which corresponds to the selected interface type and type-associated operating mode, with the external device by the receiving apparatus via the peripheral interface.

14. The data communication method according to claim 13, wherein the peripheral interface is a MMIS interface, and the types of the interfaces multiplexed by the MMIS interface include at least two selected from a group including SPI, SDIO interface, and DVB-TS.

15. The data communication method according to claim 14, wherein
the type-associated operating modes of the SPI include single-channel, double-channel, and four-channel SPI;
the type-associated operating modes of the SDIO interface include single-channel and four-channel SDIO interface;
the type-associated operating modes of the DVB-TS include DVB-TS; and wherein
among the interfaces multiplexed by the MMIS interface, respective type-associated operating modes of the SPI, the SDIO interface and the DVBTS are multiplexed.

16. The data communication method according to claim 15, wherein when the selected interface type is the SPI or SDIO interface, corresponding interface signals include an interrupt signal.

17. A peripheral interface provided on a receiving apparatus and provided with pins for communicating with an external device, wherein
one of the pins is defined as a pin for transmitting an interrupt signal to the external device, such that the external device is notified of state information indicating whether data in the pins is ready or not to be transmitted.

18. The peripheral interface according to claim 17, wherein
the peripheral interface multiplexes at least two types of interfaces; and
the pins transmit interface signals corresponding to an interface type and type-associated operating mode selected from those multiplexed by the peripheral interface.

19. The peripheral interface according to claim 18, wherein
the peripheral interface is a MMIS interface;
the types of the interfaces multiplexed by the peripheral interface include SPI and/or SDIO interface;
the type-associated operating modes of the SPI include single-channel, double-channel, and four channel SPI;
the type-associated operating modes of the SDIO interface include single-channel and four channel SDIO interface; and wherein
among the interfaces multiplexed by the MMIS interface, respective type-associated operating modes of the SPI and the SDIO interface are multiplexed.

20. The peripheral interface according to claim 19, wherein a MMIS_VLD pin, a MMIS_D0 pin, a MMIS_D1 pin and a MMIS_D2 pin of the MMIS interface are defined as four pins for receiving and transmitting data bi-directionally.

21. The peripheral interface according to claim 20, wherein a MMIS_VLD pin, a MMIS_D0 pin, a MMIS_DL pin, and a MMIS_D2 pin of the MMIS interface are defined as two pins for receiving data and the other two pins for transmitting data.
